(19) United States
(12) Patent Application Publication
(10) Pub. No.: US 2002/0118374 A1
(43) Pub. Date: Aug. 29, 2002

(54) Computer readable media having a poster/puzzle

(76) Inventor: Mark J. Wanko, Kingston, PA (US)

Correspondence Address: VOLPE AND KOENIG, P.C., SUITE 400, ONE PENN CENTER, 1617 JOHN F. KENNEDY BOULEVARD, PHILADELPHIA, PA, 19103, US

(21) Appl. No.: 09/793,273

(22) Filed: Feb. 26, 2001

(51) Int. Cl. G06F 15/00

(52) U.S. Cl. 358/1.2

(57) ABSTRACT

A computer readable media has a plurality of image files and executable instructions. Each image file is formatted to print on a standard sized sheet of printable media. Each image file is a portion of a larger image. When all of the image files are printed, the printed images are capable of being assembled into the larger image. The executable instructions perform steps including: in response to a user input, one of the image files are selected and the selected one image file is printed.

### BACKGROUND

The invention generally relates to computer readable media. In particular, the invention relates to computer readable media used for printing images.

There are various graphics software products for producing printed graphics materials, such as Adobe® Photoshop® and CorelDraw® software. Some of these graphics programs take a graphics file, such as one in JPEG, bitmap or TIFF format, and either automatically scale or allow a user ro scale the image to a desired size for reproduction on a sheet of paper, such as an 8½″×11″ sheet of paper. One drawback with these software programs is that the printed product is typically limited to one sheet of paper. Other graphics software, such as banner printing software, take information for printing, such as text and graphics, and rescales the information to print over several sheets of paper. One drawback with these software programs is that the resolution of the printed images decreases as the printed scale of the images increases. Accordingly, it is desirable to have alternate approaches to printing graphics.

### SUMMARY

A computer readable media has a plurality of image files and executable instructions. Each image file is formatted to print on a standard sized sheet of printable media. Each image file is a portion of a larger image. When all of the image files are printed, the printed images are capable of being assembled into the larger image. The executable instructions perform steps including: in response to a user input, one of the image files are selected and the selected one image file is printed.

### BRIEF DESCRIPTION OF THE DRAWING(S)

FIG. 1 is a flow chart for creating a poster/puzzle.

FIG. 2 is the simplified hardware system for creating a computer readable media with a poster puzzle.

FIG. 3 is an illustration of an image.

FIG. 4 is an illustration of partitioning the image into panels.

FIG. 5 is an illustration of a printed panel of FIG. 4.

FIG. 6 is an illustration of a printed overlapping panel of FIG. 4.

FIG. 7 is an illustration of a printed panel with assembly guidelines in the margins.

FIG. 8 is an illustration of a printed panel with assembly guidelines on the back of the printed sheet.

FIG. 9 is an illustration of overlapping panels.

FIG. 10 is an illustration of a printed overlap panel.

FIG. 11 is an illustration of a swapped colorscale panel.

FIG. 12 is an illustration of simplified hardware for an end user.

FIG. 13 is an illustration of a computer readable media.

FIG. 14 is an illustration of a displayed screen.

### DETAILED DESCRIPTION OF THE PREFERRED EMBODIMENT(S)

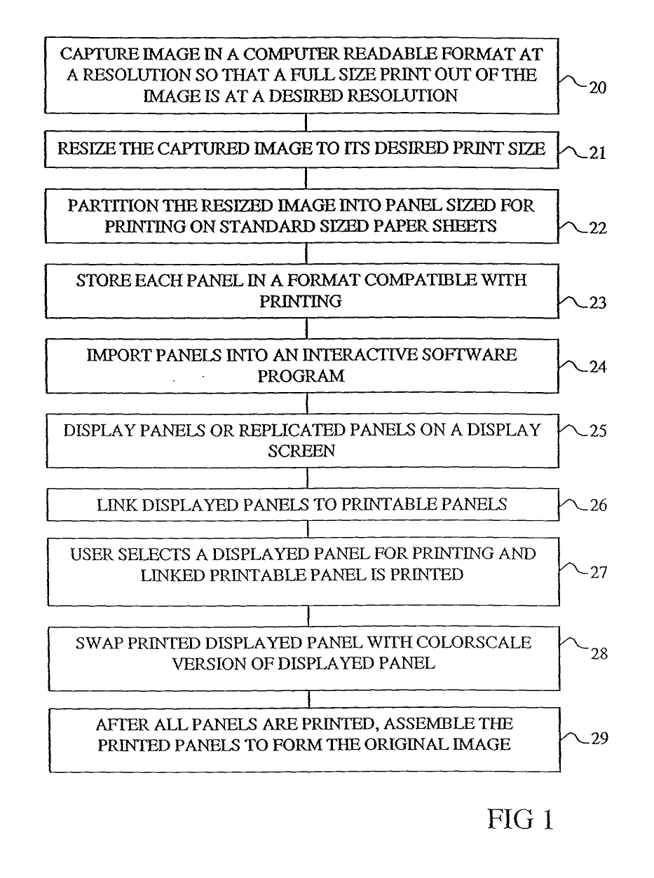

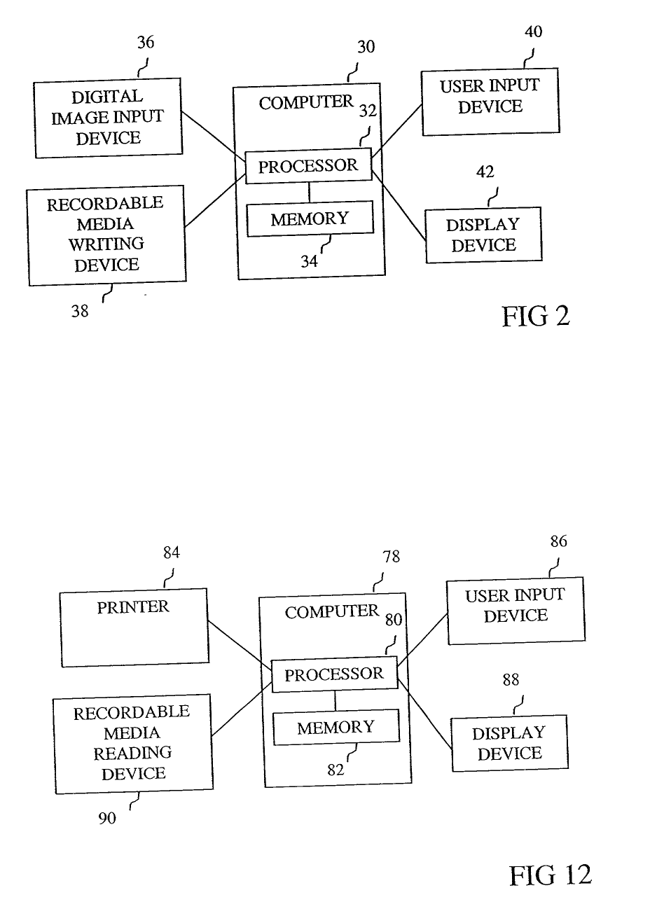

Poster/puzzle is explained in conjunction with the flow chart of FIG. 1 and the simplified hardware of FIG. 2. One application is to allow for a poster sized or larger image to be produced using standard sized paper, such as 8½″×11″ sheet of paper. The image is printed over many sheets of standard sized paper. The printed sheets are assembled, like a puzzle, to produce the desired image. Although the poster/puzzle is described as using sheets of paper, any other printable media may be used, such as transparencies, card stock, etc.

Initially, an image is selected to be printed in the poster/puzzle format. One application is to use a licensed image, such as a licensed image of a musical group or band. A desired print size is selected for the image. To illustrate, if a life size printout of a six foot tall man was desired, the desired print size may be four feet wide by six feet high. Another example would be to produce a 24″ wide by 36″ high poster.

The image is captured in a computer readable format, such as bitmap, JPEG or TIFF format, using a digital image input device 36, such as a digital scanner or digital camera, and a computer 30 having a processor 32 and an associated memory 34, at a resolution so that the full size printout will be at a desired resolution, such as 150 by 150, 300 by 300, 300 by 600, 600 by 600 or 1440 by 1440 dots per inch (DPI), 20. To illustrate, an 8″ wide by 10″ high photograph is to be printed as a 4′ wide by 5′ high full size printout at 150 by 150 DPI. To produce the desired resolution the photograph needs to be scanned at six times (48″ wide/8″ wide or 60″ high/10″ high) the desired resolution in each dimension. The photograph would preferably be scanned at 900 by 900 DPI. However, based on the allowable scanning resolutions of a particular scanner, a different resolution, such as 1440 by 1440 DPI or 600 by 600 DPI, may need to be selected. Using the preferred resolution minimizes the amount of software interpolation that may be required in the scaling of the image to its printing size. Alternately, a digital camera may be used to capture an image at the desired resolution. Using the above 8″ wide by 10″ high photograph example, the camera will record the image at 900 by 900 DPI.

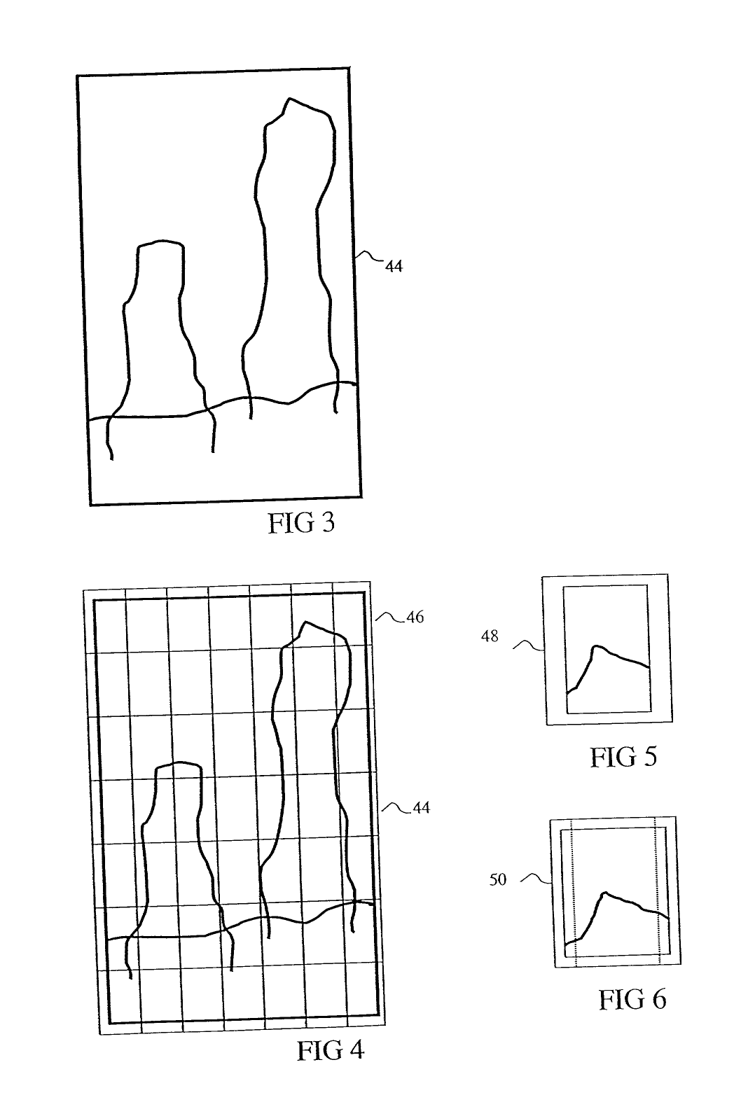

The captured image is resized to the desired size using graphics software, such as Adobe® Photoshop®, stored in the computer's memory 34, 21. To illustrate for the 8″ wide by 10″ high image, the image is scaled in each dimension by a factor of six to produce a 48″ by 60″ (4′ by 5′) image. Based on the desired paper size for the image to be printed, the image is partitioned into appropriately sized panels, 22. Typically, this is accomplished by user input through a user input device 40, such as a mouse or keypad. To illustrate, the 48″ wide by 60″ high image 44, as shown in FIG. 3, is to be printed on 8½″×11″ sheets of paper. Since most printers are not capable of printing on the entire sheet of paper, margins are preferably used as a buffer around each printed panel. As a result, one panel size may be 7″ wide by 10″ high to allow a ¾″ margin on each side of the paper and a ½″ margin on the top and bottom. However, other margin sizes can be used. The image is partitioned into 7″ wide by 10″ high panels 46 as shown in FIG. 4. FIG. 5 illustrates the eventual printout sheet 48 of one of the top panels 46 on an 8½″×11″ sheet of paper to illustrate the margins.

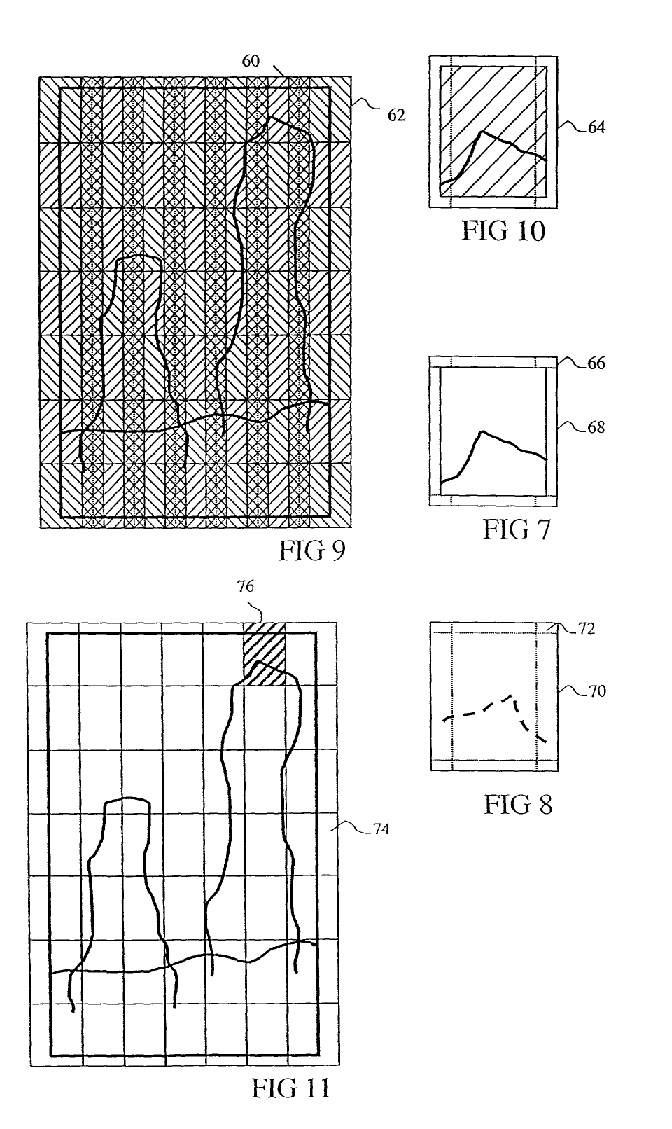

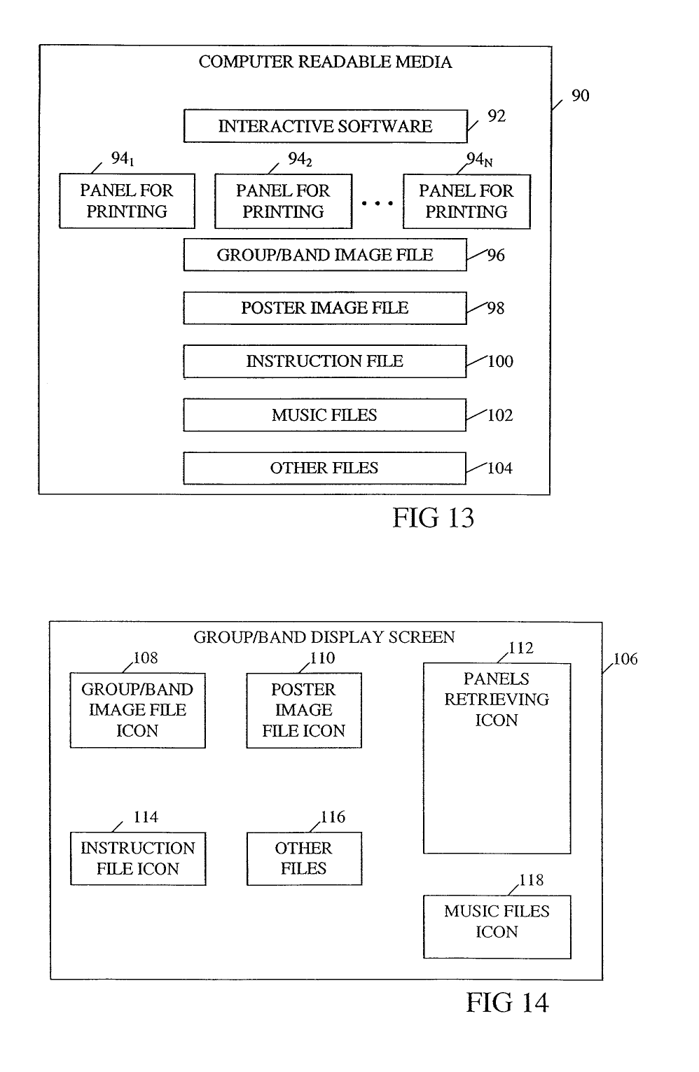

To allow for an ease in the assembly of the printed sheets of the panels, the image may be divided into overlapping panels. To illustrate for the partitioning of FIG. 4, a ¼″ overlap on the left and right side on the printed sheet 50 may be desired as shown in FIG. 6 with the non-overlap partition shown by being bordered by dotted lines. Guidelines, such as shown in FIGS. 7 and 8, may be used to ease in assembly of the printed sheets 68, 70. The guidelines 66 may be printed in the margins of the printed sheets 68, as in FIG. 7, or are printed on the back of the sheet of paper 70, as shown in FIG. 8 with the image on the other side shown as dashed lines, to facilitate assembly of the printed sheets.

The overlapping panels 60, 62 of the image 44 of FIG. 4 is shown in FIG. 9. Each overlap panel 60, 62 is indicated by a differing hatch pattern. Since the far most left and right panels 62 only overlap on one side, these panels are ¼″ wider. The original vertical partitions are shown by a dotted line. An illustration of printed sheet 50 with the hatching of FIG. 9 is illustrated in the printed sheet 64 of FIG. 10.

Each panel to be printed, in either overlap or non-overlap format, is stored in the memory 34 in a format that is compatible for printing, such as a PDF (Adobe Acrobat) or JPEG format, 23. One advantage of this approach is that each panel formatted for printing is at the desired printing resolution. This desired resolution allows for each printed sheet containing a partition to have a high print quality.

To facilitate user interaction, the image is imported into an interactive software program, such as Macromedia Flash or a proprietary software, stored in the computer's memory 34, 24. The non-overlapping panels are either replicated in the interactive program or the original panels 46 are arranged and displayed in the program, 25. The result of the replication or arranging appears the same as FIG. 4. One advantage to replicating the panels 46 is that the image can be imported into the interactive software program at a lower resolution, allowing for a quicker display of the replicated panels on a display device 42, such as a monitor.

Each displayed panel is linked to its corresponding panel formatted for printing. This allows an end user of the poster/puzzle to interactively print out the panel sheets. The hardware for an end user is shown in FIG. 11. The end user's computer 78 has a processor 80 and an associated memory 82 for executing instructions of the interactive program. When an end user of the interactive program selects a displayed panel using a user input device 86 and display device 88, the printed panel is called by the processor 80 and printed by a printer 84, 27. Once the end user prints all of the panel sheets, the printed panels can be assembled into the full image using an adhesive and a cutting device, such as tape and scissors, 29. The software used for printing may be an off-the-shelf program, such as Adobe® Acrobat®, or a custom program, such as written in C++.

For use in indicting which panels have been printed, the displayed panels 74 are replicated and stored in the scale of a color, such as a gray scale, a blue scale or a red scale image. After the displayed panel has been printed, the displayed panel 76 is shown in a color scale as shown in FIG. 11 by the hatching, 28.

One application of the poster/puzzle uses a computer readable media 90, such as a CD ROM or a DVD. The computer readable media 90 allows for transfer of the interactive software 92 and associated files from a creator of the panels computer 30 to an end user computer 78. The media is created by a recordable media writing device 38 associated with the creator's computer 30 as shown in FIG. 2. Stored on the media is the interactive software program 92, and the panels formatted for printing 94₁ to 94_{N}, such as in a PDF format.

One application of the poster/puzzle is to disseminate licensed material of a popular group or band. In such an application, additional information may stored on the computer readable media, such as a group/band image file 96 (which may be the originally captured image prior to resizing), a poster of the group/band 98 for printing on a single sheet of standard sized paper, instructions 100 on the use of the interactive software (such as in a ASCII, Microsoft® Word or PDF format), music files (such as background music or, alternately, a song of the group/band in an MP3 or WAV format) and other files. The other files may comprise graphics of the group or band to be printed on iron on paper and graphics for printing on paper for peel off stickers.

When the media is used to disseminate licensed material of a group/band, the interactive software 92 utilizes an interactive display screen 106, such as shown in FIG. 14. Through a user input, a group/band image file icon 108, poster image file icon 110, instruction file icon 114, other files icon 116, music files icon 18 and panels retrieving icon 112 can be selected on the display screen 106. By selecting either the group/band icon 108, poster icon 110 or instruction icon 114, the corresponding file 96, 98, 100 is retrieved for printing. If the music icon 18 is selected, preferably the background music is toggled on or off. Alternately, selecting the music icon 18 retrieves the associated song file is retrieved or a display screen allowing a choice of song files. If the other files icon 116 is selected, a display screen having links to the associated other files 104 is displayed. If the panel retrieving icon 112 is selected, the linked panels for printing are displayed.

What is claimed is:

1. A computer readable media with stored information, the stored information comprising:
a plurality of image files, each image file formatted to print on a standard sized printable media and each image file being a portion of a larger image, whereby when all of the plurality of image files are printed, the printed images are capable of being assembled into the larger image;
executable instructions for performing steps including:
selecting one of the image files in response to a user input; and
printing the selected one image file.

2. The computer readable media of claim 1 wherein the larger image is a licensed image.

3. The computer readable media of claim 1 wherein each image file is formatted to print at a desired resolution on the standard sized printable media sheet.

4. The computer readable media of claim 3 wherein the desired resolution is 300 by 300 dots per inch.

5. The computer readable media of claim 3 wherein the desired resolutions is 1440 by 1440 dots per inch.

6. The computer readable media of claim 3 wherein the standard sized printable medias are 8½″ by 11″ sheets of paper.

7. The computer readable media of claim 1 wherein the computer readable media is a CD ROM.

8. The computer readable media of claim 1 wherein the computer readable media is a DVD.

9. The computer readable media of claim 1 wherein the computer readable media is associated with licensed material, the computer readable media further comprising a licensed material image file capable of printing on a single standard sized sheet of paper and the larger image being an image of the licensed material.

10. The computer readable media of claim 1 further comprising for each image file a corresponding color scale version of the image file and the executable instruction steps further including:
displaying the image files on a display; and
after the selecting of one image file, replacing that one displayed image file with the color scale version of that one file on the display.

11. The computer readable media of claim 1 wherein each image file overlaps with another of the image files; whereby the assembled larger image comprises the printed images overlapped.

12. The computer readable media of claim 1 wherein each image file comprises assembly guidelines.

13. A method comprising:
inputting into a processor a machine encoded image;
segmenting the image into a plurality of panels;
converting each panel into a format compatible with printing on a printable media;
storing each converted panel onto a portable computer readable media;
retrieving and printing each stored converted panel onto a separate sheet of the printable media; and
combining the separate sheets to form a replica of the image.

14. The method of claim 13 further comprising producing the machine encoded image using a digital camera.

15. The method of claim 13 further comprising scanning an image to produce the machine encoded image.

16. The method of claim 13 further comprising:
scaling the inputted image prior to the segmenting.

17. The method of claim 16 wherein the inputted machine encoded image is at a resolution so that after scaling the scaled image is at a desired resolution.

18. The method of claim 13 wherein the printable media is a standard sized sheet of paper.

19. The method of claim 18 wherein the standard sized sheets are 8½″×11″ sheets of paper.

20. A method for producing a portable computer readable media, the method comprising:
inputting into a processor a machine encoded image;
segmenting the image into a plurality of panels;
converting each panel into a format compatible with printing on a sheet of printable media; and
storing the converted panels on the portable computer readable media.

21. The method of claim 20 wherein the portable media is a CD-ROM.

22. The method of claim 20 wherein the portable media is a DVD.
